(19) United States
(12) Patent Application Publication
(10) Pub. No.: US 2010/0279058 A1
(43) Pub. Date: Nov. 4, 2010

(54) BUILDING CONSTRUCTION ELEMENT MADE OF BAMBOO

(76) Inventor: Tsan-Tang CHIU, Tainan City (TW)

Correspondence Address: DLA PIPER LLP (US ), 2000 UNIVERSITY AVENUE, EAST PALO ALTO, CA, 94303-2248, US

(21) Appl. No.: 12/768,643

(22) Filed: Apr. 27, 2010

(30) Foreign Application Priority Data
Apr. 30, 2009 (TW) 098114371

(51) Int. Cl. B32B 7/00

(52) U.S. Cl. 428/105

(57) ABSTRACT

A building construction element includes at least one first bamboo face plate, at least one second bamboo face plate, and a core unit including a plurality of bamboo strip plates disposed between the first and second bamboo face plates. Each of the first and second bamboo face plates has longitudinal inner and outer faces, and two opposite longitudinal lateral edges between the longitudinal inner and outer faces. Each bamboo strip plate has two opposite longitudinal faces, and opposite first and second longitudinal lateral edges between the longitudinal faces of a corresponding bamboo strip plate. The bamboo strip plates are interconnected to each other through the longitudinal faces thereof. The first and second longitudinal lateral edges of each bamboo strip plate are connected respectively to the longitudinal inner faces of the first and second bamboo face plates.

### CROSS-REFERENCE TO RELATED APPLICATION

This application claims priority of Taiwanese Application No. 098114371, filed on Apr. 30, 2009.

### BACKGROUND OF THE INVENTION

1. Field of the Invention

This invention relates to a building construction element, more particularly to a building construction element made of bamboo.

2. Description of the Related Art

In home renovation work, wood materials are commonly. Since it usually takes about ten years or so to harvest wood, use of wood materials is not economical and runs counter to worldwide afforestation efforts.

Since bamboo can be harvested within 3-5 years, this material is increasingly being used in construction. However, processed bamboo pieces usually have elongated flat shapes, so that the scope of use of bamboo is limited. Although processed bamboo pieces can be connected together to form a bamboo panel, the strength thereof is inferior to that of a wood panel. Hence, use of bamboo in the construction is very restricted.

### SUMMARY OF THE INVENTION

Therefore, the object of the present invention is to provide a building construction element that is made of bamboo and that has a strong structure.

According to this invention, a building construction element comprises at least one first bamboo face plate, at least one second bamboo face plate, and a core unit. The first bamboo face plate has longitudinal inner and outer faces, and two opposite longitudinal lateral edges between the longitudinal inner and outer faces. The second bamboo face plate is opposite to the first bamboo face plate, and has longitudinal inner and outer faces, and two opposite longitudinal lateral edges between the longitudinal inner and outer faces of the second bamboo face plate. The core unit includes a plurality of bamboo strip plates disposed between the first and second bamboo face plates. Each of the bamboo strip plates has two opposite longitudinal faces, and opposite first and second longitudinal lateral edges between the longitudinal faces of a corresponding bamboo strip plate. The bamboo strip plates are interconnected to each other through the longitudinal faces thereof. The first and second longitudinal lateral edges of each bamboo strip plate are connected respectively to the longitudinal inner faces of the first and second bamboo face plates.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a building construction element according to the first preferred embodiment of the present invention;

FIG. 2 is a partly exploded perspective view of the first preferred embodiment;

FIG. 3 is a sectional view of the first preferred embodiment;

FIG. 4 is a fragmentary perspective view of the first preferred embodiment, illustrating how the length of the building construction element of the present invention can be increased;

FIG. 5 illustrates a plurality of the building construction elements of the first preferred embodiment being interconnected to form a panel-shaped construction element; and

FIG. 6 is a perspective view of a building construction element according to the second preferred embodiment of the present invention.

### DETAILED DESCRIPTION OF THE PREFERRED EMBODIMENTS

Before the present invention is described in greater detail, it should be noted that the same reference numerals have been used to denote like elements throughout the specification.

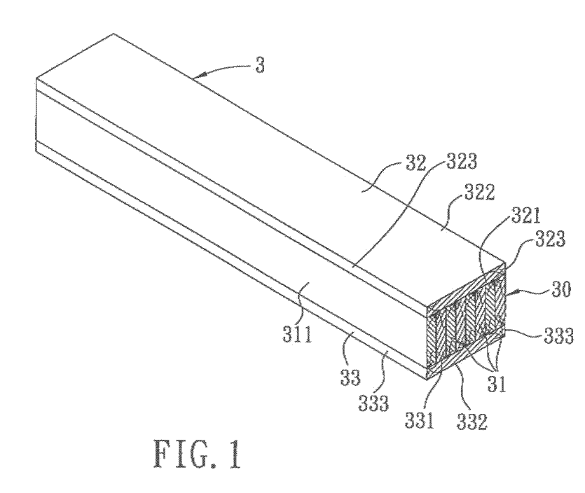

Referring to FIGS. 1 to 3, a building construction element 3 according to the first preferred embodiment of the present invention is shown to comprise a first bamboo face plate 32, a second bamboo face plate 33, and a core unit 30.

The first and second bamboo face plates 32, 33 are spaced apart from and parallel to each other. Each of the first and second bamboo face plates 32, 33 has longitudinal inner and outer faces 321, 331, 322, 332, and two opposite longitudinal lateral edges 323, 333 between the longitudinal inner and outer faces 321, 331, 322, 332.

The core unit 30 includes a plurality of interconnected bamboo strip plates 31 disposed between the first and second bamboo face plates 32, 33. Each of the bamboo strip plates 31 has two opposite longitudinal faces 311, and opposite first and second longitudinal lateral edges 312, 313 between the longitudinal faces 311. The bamboo strip plates are interconnected to each other through the longitudinal faces 311 thereof. In this embodiment, the longitudinal inner faces 321, 331 of the first and second bamboo face plates 32, 33 are connected respectively to the first and second longitudinal lateral edges 312, 313 of the bamboo strip plates 33 in a longitudinal direction along the lengths of the bamboo strip plates 31 to form a single building construction element 3 having a predetermined length.

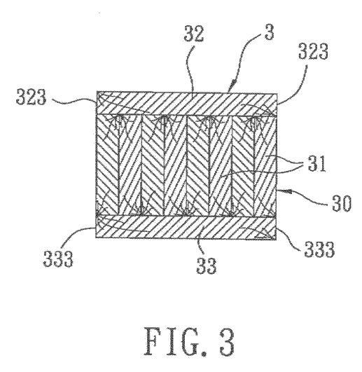

Further, with reference to FIGS. 1 and 3, left and right outermost longitudinal faces 311 of the core unit 30 are flush with the longitudinal lateral edges 323, 333 of the first and second bamboo face plates 32, 33. The bamboo strip plates 31 are fixed to the first and second bamboo face plates 32, 33 by using an adhesive. However, the present invention is not limited in this regard.

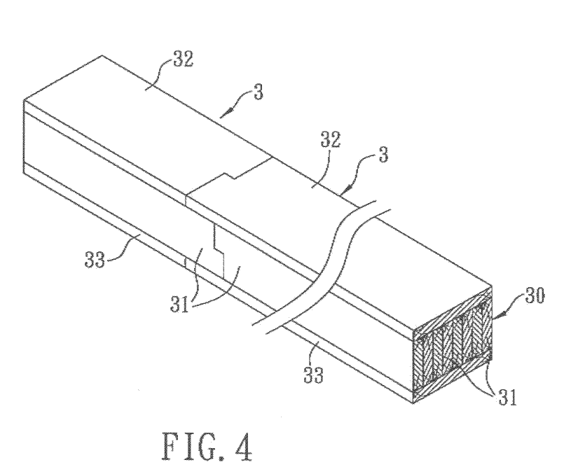

Moreover, the length of the building construction element 3 can be increased as desired by interconnecting two connecting ends of two adjacent building construction elements 3 through a protrusion-and-groove engaging method, as shown in FIG. 4. Since the protrusion-and-groove engaging method is known in the art, and is not the main aspect of the present invention, a detailed description thereof is dispensed herewith.

Through the interconnection of the bamboo strip plates 31 to each other, and through the connection of the bamboo strip plates 31 between the longitudinal inner faces 321, 331 of the first and second bamboo face plates 32, 33 so as to form a beam-like construction element, the structural strength of the building construction element 3 of the present invention along the longitudinal and lateral directions is greatly enhanced. Hence, the building construction element 3 of the present invention can be used as a beam in construction.

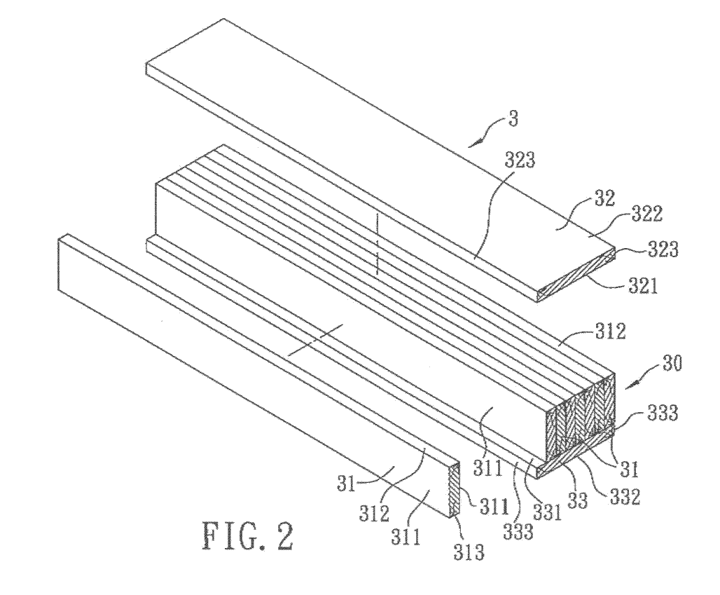

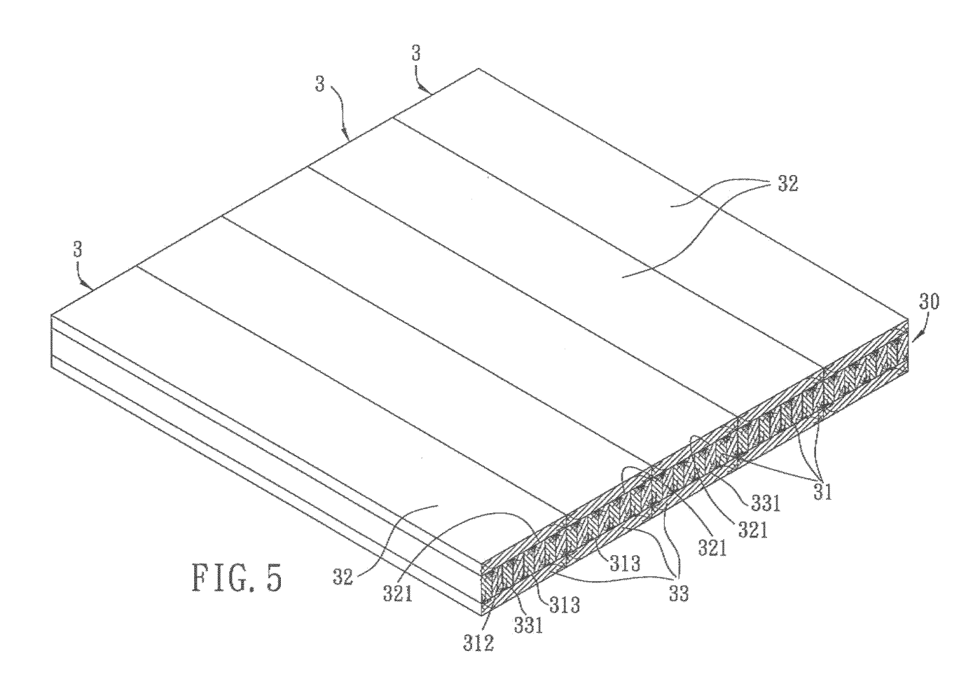

Additionally, a plurality of the building construction elements 3 may be interconnected, as shown in FIG. 5. Referring to FIGS. 2 and 5, a plurality of the first bamboo face plates 32 are interconnected to each other at the longitudinal lateral edges 323 thereof. A plurality of the second bamboo face plates 33 are interconnected to each other at the longitudinal lateral edges 333 thereof. The longitudinal inner faces 321, 331 of the first and second bamboo face plates 32, 33 are connected respectively to the first and second longitudinal lateral edges 312, 313 of the bamboo strip plates 31 in a longitudinal direction along the lengths of the bamboo strip plates 31 so as to form a panel-shaped construction element. The structural strength of the building construction element 3 of the present invention can be similarly enhanced. Hence, the interconnected building construction elements 3 of the present invention can be used in place of a wood panel in construction.

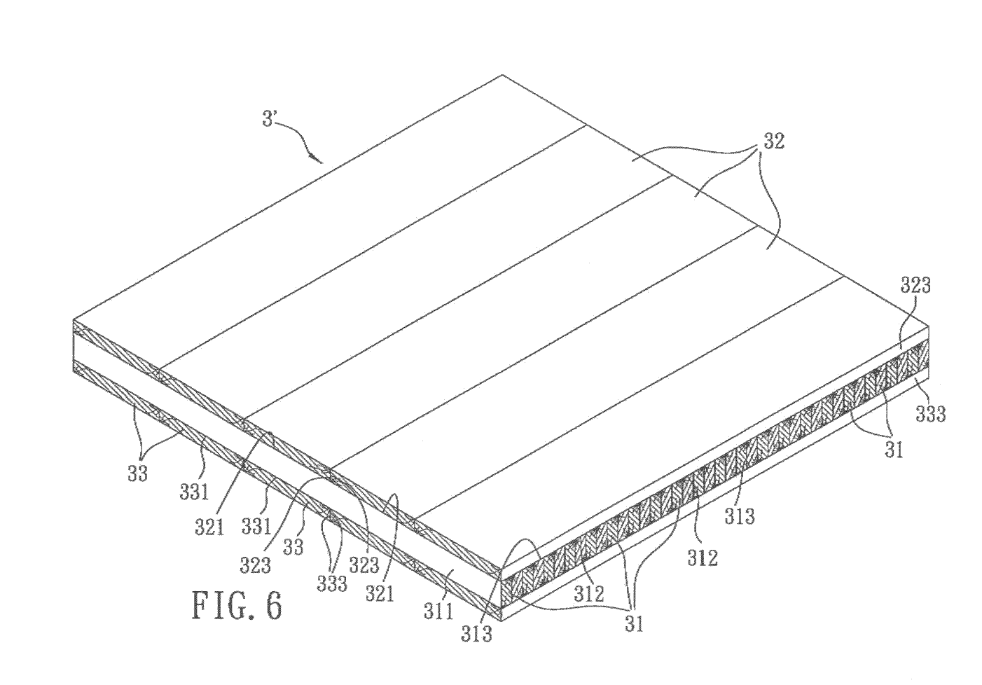

Referring to FIG. 6, a building construction element 3′ according to the second preferred embodiment of this invention is shown to be similar to the first preferred embodiment. However, in this embodiment, the building construction element 3′ includes a plurality of first bamboo face plates 32 interconnected to each other at the longitudinal lateral edges 323 thereof, and a plurality of second bamboo face plates 33 interconnected to each other at the longitudinal lateral edges 333 thereof. The longitudinal inner faces 321 of the first bamboo face plates 32 are connected to the first longitudinal lateral edges 312 of the bamboo strip plates 31 in a transverse direction transverse to the lengths of the bamboo strip plates 31. The longitudinal inner faces 331 of the second bamboo face plates 33 are connected to the second longitudinal lateral edges 313 of the bamboo strip plates 31 in a transverse direction transverse to the lengths of the bamboo strip plates 31. Similarly, the structural strength of the building construction element 3′ of the present invention can be greatly enhanced.

In an alternative embodiment, only the first or second bamboo face plates 32, 33 may be varied. That is, only the longitudinal inner faces 321, 331 of the first or second bamboo face plates 32, 33 may be connected to the first longitudinal lateral edges 312 of the bamboo strip plates 31 in a transverse direction transverse to the lengths of the bamboo strip plates 31.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A building construction element comprising:
at least one first bamboo face plate having longitudinal inner and outer faces, and two opposite longitudinal lateral edges between said longitudinal inner and outer faces;
at least one second bamboo face plate opposite to said first bamboo face plate and having longitudinal inner and outer faces, and two opposite longitudinal lateral edges between said longitudinal inner and outer faces of said second bamboo face plate; and
a core unit including a plurality of bamboo strip plates disposed between said first and second bamboo face plates, each of said bamboo strip plates having two opposite longitudinal faces, and opposite first and second longitudinal lateral edges between said longitudinal faces of a corresponding said bamboo strip plate, said bamboo strip plates being interconnected to each other through said longitudinal faces thereof, said first and second longitudinal lateral edges of each of said bamboo strip plates being connected respectively to said longitudinal inner faces of said first and second bamboo face plates.

2. The building construction element of claim 1, wherein said longitudinal inner faces of said first and second bamboo face plates are connected respectively to said first and second longitudinal lateral edges of said bamboo strip plates in a longitudinal direction along the lengths of said bamboo strip plates.

3. The building construction element of claim 1, which comprises a plurality of said first bamboo face plates interconnected to each other at said longitudinal lateral edges thereof, and a plurality of said second bamboo faces plates interconnected to each other at said longitudinal lateral edges thereof, said longitudinal inner faces of said first and second bamboo face plates being connected respectively to said first and second longitudinal lateral edges of said bamboo strip plates in a longitudinal direction along the lengths of said bamboo strip plates.

4. The building construction element of claim 1, which comprises a plurality of said first bamboo face plates interconnected to each other at said longitudinal lateral edges thereof, said longitudinal inner faces of said first bamboo face plates being connected to said first longitudinal lateral edges of said bamboo strip plates in a transverse direction transverse to the lengths of said bamboo strip plates.

5. The building construction element of claim 3, which comprises a plurality of said second bamboo face plates interconnected to each other at said longitudinal lateral edges thereof, said longitudinal inner faces of said second bamboo face plates being connected to said second longitudinal lateral edges of said bamboo strip plates in a transverse direction transverse to the lengths of said bamboo strip plates.
